(19) United States
(12) Patent Application Publication
(10) Pub. No.: US 2026/0072414 A1
(43) Pub. Date: Mar. 12, 2026

(54) CLASSIFICATION OF ASPECTS OF MANUFACTURING EQUIPMENT USING ARTIFICIAL INTELLIGENCE

(71) Applicant: Applied Materials, Inc., Santa Clara, CA (US)

(72) Inventors: Sidharth Bhatia, Santa Cruz, CA (US); Ananthan Raghunathan, Sunnyvale, CA (US); Steven Eduard Babayan, Los Altos, CA (US)

(21) Appl. No.: 18/828,202

(22) Filed: Sep. 9, 2024

(51) Int. Cl. G05B 13/02; G06F 40/20

(52) U.S. Cl. CPC G05B 13/0265; G06F 40/20

(57) ABSTRACT

A method includes generating or receiving an input for an AI model. The input includes a description of a set of categories to which a parameter or component of a manufacturing system may belong. The input further includes a number of examples each including a parameter or component name and an indication of which category of the set of categories the parameter or component belongs to. The input further includes a name of a target parameter or component to be categorized according to the set of categories.

The method further includes processing the input using the AI model to generate an output including a category associated with the target parameter or component. The method further includes performing a corrective action in view of the category associated with the target parameter or component.

### TECHNICAL FIELD

The present disclosure relates to methods associated with artificial intelligence models used for assessment of manufacturing equipment. More particularly, the present disclosure relates to classification of aspects of manufacturing equipment using artificial intelligence.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Machine learning models are used in various process control and predictive functions associated with manufacturing equipment. Manufacturing equipment may be associated with a large number of parameters (e.g., numerical or non-numerical settings), components, and other aspects that may perform various functions and/or generate data.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes generating or receiving an input for an AI model. The input includes a description of a set of categories to which a parameter or component of a manufacturing system may belong. The input further includes a number of examples each including a parameter or component name and an indication of which category of the set of categories the parameter or component belongs to. The input further includes a name of a target parameter or component to be categorized according to the set of categories. The method further includes processing the input using the AI model to generate an output including a category associated with the target parameter or component. The method further includes performing a corrective action in view of the category associated with the target parameter or component.

In another aspect of the present disclosure, a method includes obtaining training data. The training data includes names of a number of parameters or components of one or more manufacturing systems. The training data further includes categorizations of each of the parameters or components. The method further includes updating one or more parameters of a trained AI model to generate a retrained model. The retraining model is configured to obtain as input a name of a target parameter or component and generate output indicating classification of the parameter or component into a category corresponding to the categorizations of each of the plurality of parameters or components.

In another aspect of the present disclosure, a non-transitory machine-readable storage medium stores instructions which, when executed by a processing device, cause the processing device to perform operations including generating or receiving an input for an AI model. The input includes a description of a set of categories to which a parameter or component of a manufacturing system may belong. The input further includes a number of examples each including a parameter or component name and an indication of which category of the set of categories the parameter or component belongs to. The input further includes a name of a target parameter or component to be categorized according to the set of categories. The operations further include processing the input using the AI model to generate an output including a category associated with the target parameter or component. The operations further include performing a corrective action in view of the category associated with the target parameter or component.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for utilizing an artificial intelligence (AI) model via prompt engineering to perform classification of parameters and/or components, according to some embodiments.

FIG. 4C is a flow diagram of a method for training a machine learning or AI model to perform classification operations, according to some embodiments.

FIG. 5 is a block diagram illustrating a computer system, according to some embodiments.

### DETAILED DESCRIPTION

Described herein are technologies related to categorization of components of a manufacturing system for improved performance. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. In some embodiments, trained machine learning models are utilized to improve performance of manufacturing equipment. Machine learning models may be applied in several ways associated with processing chambers and/or manufacturing equipment. A machine learning model may receive input data, indicative of one or more properties, components, or processes in association with a process chamber, and generate output based on the input.

Processing systems (e.g., process tools, process chambers, etc.) may include many components, subsystems, devices, sensors, parameters, and the like. For example, a process tool for substrate processing (e.g., semiconductor wafer processing) may include tens of thousands of equipment constants (e.g., parameters), and on the order of ten thousand sensors.

Of interest in processing systems is achieving predictable, repeatable, and/or reliable process results. For example, consistent process conditions, consistent substrate properties, consistent manufactured product performance, and the like improves efficiency of a manufacturing facility, decreasing cost, material waste, waste associated with disposing of defective products, decreases energy expenditure, decreases environmental impact, etc., of the manufacturing process.

In some systems, a subset of properties and/or data of the many components and parameters may be well correlated with properties of manufactured products. There may be a number of parameters and components (e.g., most parameters and components, in some cases) which are not particularly well correlated with substrate properties. As examples, some parameters that are not well correlated with substrate properties may include parameters related to robot speed, exhaust valve opening speed, parameters adjusted in feedback loops such that the absolute values of the parameters are of less relevance, etc. Some components (e.g., sensors) that are not well correlated with substrate properties may include sensors monitoring operation of actuators, robots, valves, etc., sensors monitoring actions performed far from a processing volume of the process tool, etc. In some systems, several orders of magnitude fewer components and parameters may be of interest with respect to improving process results than exist in association with a process tool, e.g., on the order of a few hundred components and parameters.

In some systems, it may be of interest to identify sensors, parameters, and/or other operating components or subsystems that are well correlated to manufacturing system performance, e.g., product properties. In some systems, this may be based on labeling by a subject matter expert, e.g., based on internal naming conventions of parameter and sensor names (e.g., name labels used to algorithmically differentiate between the parameters and sensors). Labeling many (e.g., tens of thousands) of components and parameters of a process system based on criticality to process results by subject matter experts is an extremely tedious task, including many hours of work.

In some systems, it may be of interest to identify sensors, parameters, and/or other operating components of a process system belonging to a target subsystem, or it may be of interest to categorize parameters and components into relevant process tool subsystems. Similar to challenges related to determining criticality of such components and parameters, subject matter categorization into subsystems may be a time consuming, expensive, or inconvenient process for determining subsystems of various components in the process system.

Aspects of the present disclosure may address one or more shortcomings of conventional solutions. In some embodiments, prompt engineering of input to a trained machine learning model may be utilized to categorize manufacturing system parameters (e.g., equipment constants) and components (e.g., sensors) into one or more sets of categories. Categorization may include level of criticality, e.g., relevance to product quality, manufacturing process quality, substrate properties, etc. Categorization may include subsystem assignment.

In some embodiments, prompt engineering may include the names (e.g., identifiers) of one or more process system parameters or components. The prompt engineering may include a description of a set of categories to which the parameters or components may belong, e.g., a description of several available subsystems, a description of several levels of criticality to substrate properties defined by a strength of a relationship between values associated with the parameter or component and properties of a product, or the like. The prompt engineering may include a number of examples of parameter and/or component names, categorized in accordance with the category descriptions provided. The trained machine learning model (e.g., artificial intelligence or AI model) may be a natural language processing model, a large language model (LLM), or the like.

In some embodiments, target output of the trained machine learning model may include categorization of the parameter or component into one or more categories (e.g., selection of one category each from multiple sets of categories, such as criticality and subsystem assignment). Target output (and prompt engineering) may include a modified name of the component or parameter, e.g., a nickname, shortened name, or other name that may more clearly indicate to a user the function or purpose of the component or parameter.

In some embodiments, the system may further determine and/or execute a corrective action. For example, a large number of potential parameters of a manufacturing system may be potential targets for updates in an attempt to improve performance of the manufacturing system. Categorization may narrow the number of potential target parameters based on criticality, subsystem, or other categorizations. A alert may be provided to a user of a more focused set of potential adjustments to be made. In some embodiments, the system may determine one or more parameters to adjust, e.g., based on reference values. In some embodiments, adjustment to one or more parameters may be made based on the categorization to improve process results of the manufacturing equipment.

In some embodiments, categorization may include a level of data access. For example, some data may be targeted to be accessible to anyone with access to the manufacturing tool, some data may be targeted to be accessible to technicians of the tool, some data may be targeted to be accessible only to an owner or manager of the tool, some data may be targeted to be available only to a support team, etc. Categorization output of the machine learning model (and prompt engineering input) may include categorization into level or category of data accessibility. In some embodiments, the system may further assign data output to a level of data accessibility, may enact operations for providing data to target recipients such as by adjusting parameters defining data access, or the like.

In some embodiments, a machine learning model may be trained to perform operations related to categorizing parameter and/or components of a manufacturing system. Training the machine learning model may include training a natural language processing model, a LLM, or the like. Training the machine learning model may include providing training data including names of components and/or parameters of one or more manufacturing systems. Training the machine learning model may include providing training data indicating categorizations of the components and/or parameters into one or more categories. Training the machine learning model may include updating one or more parameters of a trained model to generate a retrained model (e.g., retraining AI model), configured to obtain names of parameters and/or components and provide one or more categories the parameters and/or components are predicted to belong to.

In some embodiments, a retraining scheme may be utilized that includes adjusting a small number of parameters, compared to parameters of the full model (e.g., a full LLM). A retraining scheme may include parameter-efficient fine-tuning operations. A retraining scheme may include a low-rank adaptation.

Methods and systems of the present disclosure provide improvements over conventional solutions. In particular, it may be a time consuming process to manually categorize many (e.g., many tens of thousands) of parameters and/or components of a manufacturing system. Specifically, manual categorization may be performed by valuable and expensive subject matter experts, while checking, confirming, and/or validating categorizations provided by a trained model may be significantly less costly.

In one aspect of the present disclosure, a method includes generating or receiving an input for an AI model. The input includes a description of a set of categories to which a parameter or component of a manufacturing system may belong. The input further includes a number of examples each including a parameter or component name and an indication of which category of the set of categories the parameter or component belongs to. The input further includes a name of a target parameter or component to be categorized according to the set of categories. The method further includes processing the input using the AI model to generate an output including a category associated with the target parameter or component. The method further includes performing a corrective action in view of the category associated with the target parameter or component.

In another aspect of the present disclosure, a method includes obtaining training data. The training data includes names of a number of parameters or components of one or more manufacturing systems. The training data further includes categorizations of each of the parameters or components. The method further includes updating one or more parameters of a trained AI model to generate a retrained model. The retraining model is configured to obtain as input a name of a target parameter or component and generate output indicating classification of the parameter or component into a category corresponding to the categorizations of each of the plurality of parameters or components.

In another aspect of the present disclosure, a non-transitory machine-readable storage medium stores instructions which, when executed by a processing device, cause the processing device to perform operations including generating or receiving an input for an AI model. The input includes a description of a set of categories to which a parameter or component of a manufacturing system may belong. The input further includes a number of examples each including a parameter or component name and an indication of which category of the set of categories the parameter or component belongs to. The input further includes a name of a target parameter or component to be categorized according to the set of categories. The operations further include processing the input using the AI model to generate an output including a category associated with the target parameter or component. The operations further include performing a corrective action in view of the category associated with the target parameter or component.

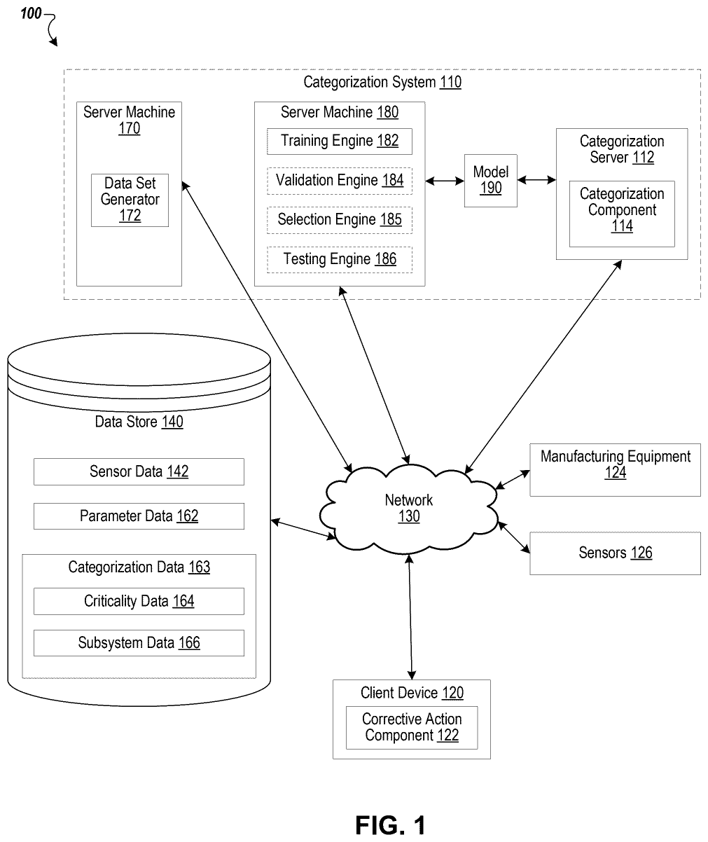

FIG. 1 is a block diagram illustrating an exemplary system 100 (exemplary system architecture), according to some embodiments. The system 100 includes a client device 120, manufacturing equipment 124, sensors 126, categorization server 112, and data store 140. The categorization server 112 may be part of categorization system 110. Categorization system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data and current sensor data. Current sensor data may be associated with a product currently being processed, a product recently processed, a number of recently processed products, etc. Historical sensor data may include data stored associated with previously produced products. Historical sensor data may be used to train a machine learning model, e.g., model 190. Historical sensor data may include attribute data, e.g., labels of manufacturing equipment ID or design, sensor ID, type, and/or location, label of a state of manufacturing equipment, such as a present fault, service lifetime, etc.

Sensor data 142 may include sensor data values, as well as sensor names. Sensor names may include identifiers for distinguishing between various sensors associated with manufacturing equipment 124, e.g., names indicating some aspect of function of the sensor, such as “ForelinePressureSensor,” “RFReflectedPowerSensor,” or any other name and/or naming convention for identifying sensors. In some embodiments, naming conventions for sensors 126 may encode, in addition to function of the sensor, information related to one or more categorizations to which the sensor may belong. For example, criticality of the sensor (e.g., strength of a relationship between sensor data values, hardware components, calibration parameters, calibration status, etc.; and properties of a processed substrate), relevant subsystem(s) of manufacturing equipment 124 to which the sensor relates, etc., may be encoded in (e.g., human-generated) sensor names. Sensor data 142 may further include data of interest with respect to various sensors. Data of interest may include categorizations (e.g., which may be stored as part of categorization data 163), but may also include other data of interest that may be predicted by a trained machine learning model, such as sensor nicknames (e.g., for quick reference by a human not requiring subject matter expertise to understand), target data accessibility parameters (e.g., various groups of operators, technicians, owners, etc., who are targeted to have access to data generated by the sensor), etc. There may be similar data associated with other components (e.g., other than sensors, including identifying names, values, parameters, etc.) included in data store 140, e.g., component data sharing one or more features with sensor data 142.

Parameter data 162 may include names of one or more parameters (e.g., equipment constants) related to manufacturing equipment 124. Parameters may include numerical values related to operation of one or more components of manufacturing equipment 124, related to operations of sensors 126 (e.g., thresholds or gain values associated with sensors 126), other parameters related to components of the system (e.g., non-numerical parameters such as an indication of a model or part type of a component), etc. Parameter data 162, similar to sensor data 142, may further include data that may be of interest to a user, for training a machine learning model, or the like associated with parameters, such as categorization (e.g., criticality, subsystem assignment, data access), parameter nicknames, etc.

Categorization data 163 may include data for training of a machine learning model with respect to manufacturing system parameters (e.g., equipment constants) and/or components (e.g., sensors). Categorization data 163 may include data for training or retraining of a machine learning or AI model, e.g., historical categorization data, human-labeled categorization data, etc. Criticality, subsystem, or other categorization data may be generated based on data. For example, correlation between parameter values or sensor data values and substrate properties may be found, and a degree of criticality of the parameter or component assigned based on the strength of the correlation. The criticality may then be used for training (or retraining) a machine learning model for categorizing parameters and/or components into degrees of criticality. Categorization data 163 may include criticality data 164, subsystem data 166, data access information, or other categorizations of interest in connection with manufacturing equipment 124 and/or sensors 126.

In some embodiments, categorization system 110 may generate categorization data 163 using supervised machine learning (e.g., categorization data 163 includes output from a machine learning model that was trained using labeled data, such as sensor or parameter names labeled with various categorizations). In some embodiments, categorization system 110 may generate categorization data 163 using unsupervised machine learning (e.g., categorization data 163 includes output from a machine learning model that was trained using unlabeled data, output may include clustering results, principle component analysis, anomaly detection, etc.). In some embodiments, categorization system 110 may generate categorization data 163 using semi-supervised learning (e.g., training data may include a mix of labeled and unlabeled data, etc.). In some embodiments, categorization system 110 may further generate complimentary data to categorization data, e.g., data indicative of natural or understandable nicknames of various parameters, sensors, components, or the like.

In some embodiments, categorization data (and other accompanying data, such as nickname data) may be generated based on output of a machine learning or AI model trained for general language processing techniques, e.g., a natural language processing model, a large language model (LLM), or the like. In some embodiments, categorization data may be generated based on output of a machine learning model trained specifically in relation to manufacturing equipment, parameter characterization, or the like. In some embodiments, output data may be generated by a model initially trained for general language processing techniques, with parameters tuned (e.g., during retraining operations) to generate output relevant to manufacturing equipment 124. In some embodiments, retraining may be performed via parameter-efficient fine-tuning methods, low-rank adaptation methods, or the like.

Client device 120, manufacturing equipment 124, sensors 126, categorization server 112, data store 140, server machine 170, and server machine 180 may be coupled to each other via network 130 for generating categorization data 163, e.g., for performance of corrective actions. In some embodiments, network 130 may provide access to cloud-based services. Operations performed by client device 120, categorization system 110, data store 140, etc., may be performed by virtual cloud-based devices.

In some embodiments, network 130 is a public network that provides client device 120 with access to the categorization server 112, data store 140, and other publicly available computing devices. In some embodiments, network 130 is a private network that provides client device 120 access to manufacturing equipment 124, sensors 126, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the categorization system 110, receives output (e.g., categorization data 163) from the categorization system 110, determines a corrective action based on the output, and causes the corrective action to be implemented. In some embodiments, corrective action component 122 obtains sensor data 142 associated with manufacturing equipment 124 (e.g., from data store 140, etc.) and provides sensor data associated with the manufacturing equipment 124 to categorization system 110.

In some embodiments, corrective action component 122 receives an indication of a corrective action from the categorization system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

Performing manufacturing processes that result in defective products can be costly in time, energy, products, components, manufacturing equipment 124, the cost of identifying the defects and discarding the defective product, etc. By inputting sensor data 142 and/or parameter data 162 into categorization system 110, receiving output of categorization data 163, and performing a corrective action based on the categorization data 163, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting sensor data 142 and/or parameter data 162 to model 190, receiving output of categorization data 163, and performing a corrective action (e.g., predicted operational maintenance, such as replacement, processing, cleaning, etc. of components) based on the categorization data 163, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting sensor data 142 and/or parameter data 162 to categorization system 110, receiving output categorization data 163, and performing a corrective action (e.g., determined by criticality and/or subsystem assignment of one or more parameters or components), system 100 can have the technical advantage of using optimal manufacturing parameters (e.g., hardware parameters, process parameters, optimal design) to avoid costly results of suboptimal manufacturing parameters.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the categorization data 163 indicates a predicted abnormality, such as an abnormality of the product, a component, or manufacturing equipment 124). In some embodiments, performance of the corrective action includes causing updates to one or more manufacturing parameters. For example, once determining that a sensor or parameter is of high criticality based on categorization data 163, parameters may be updated to improve performance of manufacturing procedures by manufacturing equipment 124. In some embodiments performance of a corrective action may include retraining a machine learning model associated with manufacturing equipment 124, e.g., model 190 for providing categorization data. In some embodiments, performance of a corrective action may include training a new machine learning model associated with manufacturing equipment 124.

Categorization server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of categorization server 112, server machine 170, server machine 180, data store 140, etc., may be performed by a cloud computing service, cloud data storage service, etc.

Categorization server 112 may include a categorization component 114. In some embodiments, the categorization component 114 may receive sensor data 142, and/or parameter data 162 (e.g., receive from the client device 120, retrieve from the data store 140) and generate output (e.g., categorization data 163), which may in some embodiments may be used for performing corrective action associated with the manufacturing equipment 124 based on the current data.

Manufacturing equipment 124 may be associated with one or more machine leaning models, e.g., model 190. Machine learning models associated with manufacturing equipment 124 may perform many tasks, including process control, classification, categorization, performance predictions, etc. Model 190 may be trained using data associated with manufacturing equipment 124 or products processed by manufacturing equipment 124, e.g., sensor data 142 (e.g., collected by sensors 126), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, the various models discussed in connection with model 190 (e.g., supervised machine learning model, unsupervised machine learning model, etc.) may be combined in one model (e.g., an ensemble model), or may be separate models.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, parameter data 162, and categorization data 163.

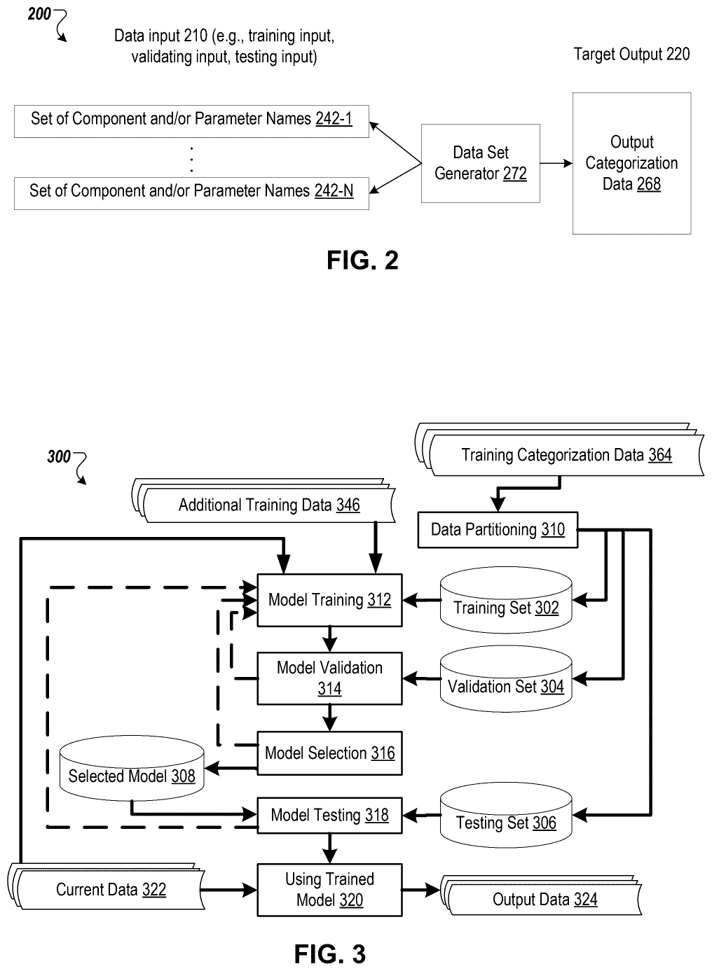

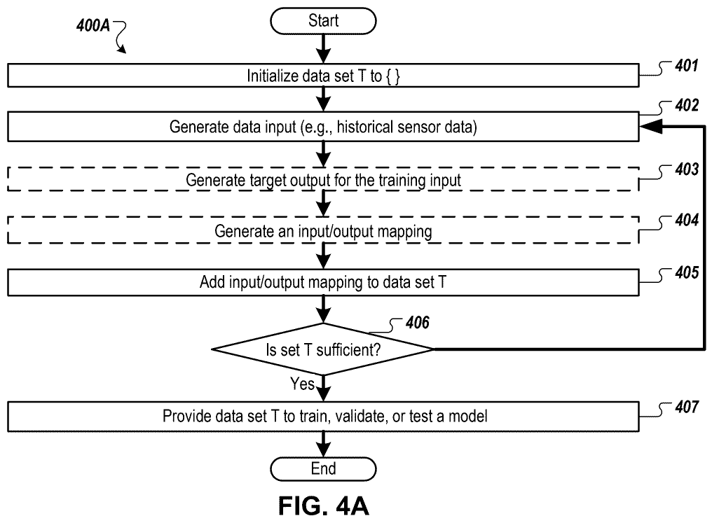

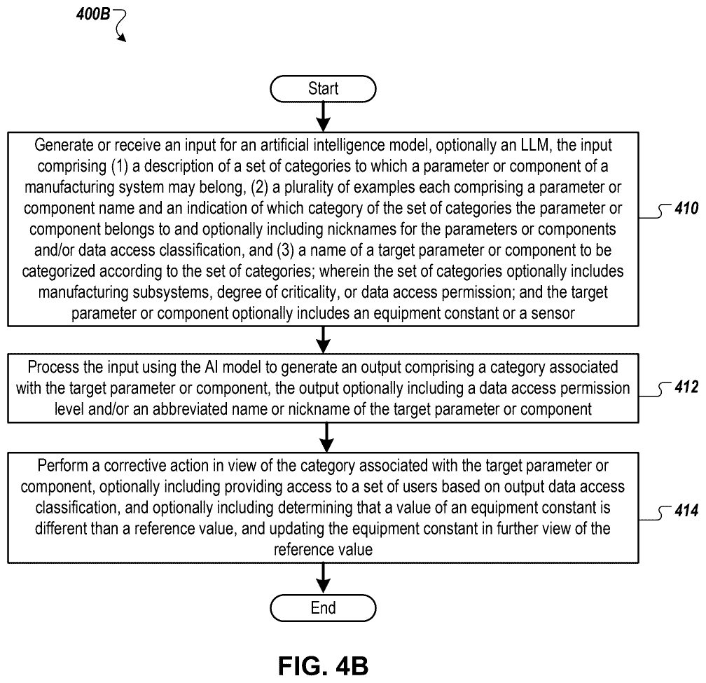

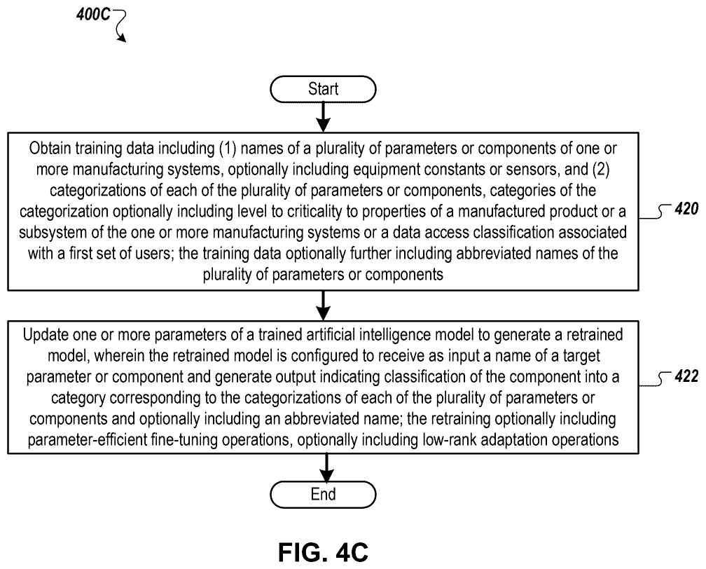

In some embodiments, categorization system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition historical data into a training set (e.g., sixty percent of the historical data), a validating set (e.g., twenty percent of the historical data), and a testing set (e.g., twenty percent of the historical data).

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172.

Validation engine 184 may be capable of validating a trained model 190 using a corresponding set of features of the validation set from data set generator 172. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190. Testing engine 186 may be capable of testing a trained model 190 using a corresponding set of features of a testing set from data set generator 172. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs. Patterns in the data sets can be found that map the data input to the target output (the correct answer, a logical next set of words output by an LLM, or the like), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Categorization component 114 may provide current data to model 190 and may run model 190 on the input to obtain one or more outputs. For example, categorization component 114 may provide current sensor data 142 and/or parameter data 162 to model 190 and may run model 190 on the input to obtain one or more outputs. Categorization component 114 may be capable of determining (e.g., extracting) categorization data 163 from the output of model 190. Categorization component 114 may determine (e.g., extract) confidence data from the output that indicates a level of confidence that categorization data 163 is an accurate predictor of categorizations associated with components and parameters of manufacturing equipment 124. Categorization component 114 or corrective action component 122 may use the confidence data to decide whether to cause a corrective action associated with the manufacturing equipment 124 based on categorization data 163.

The confidence data may include or indicate a level of confidence that the categorization data 163 is an accurate prediction for products or components associated with at least a portion of the input data. In one example, the level of confidence is a real number between 0 and 1 inclusive, where 0 indicates no confidence that the categorization data 163 is an accurate prediction for categorization of parameters and components of manufacturing equipment 124 and 1 indicates absolute confidence that the categorization data 163 accurately predicts properties of parameters and components of manufacturing equipment 124. Responsive to the confidence data indicating a level of confidence below a threshold level for a predetermined number of instances (e.g., percentage of instances, frequency of instances, total number of instances, etc.) categorization component 114 may cause trained model 190 to be re-trained. In some embodiments, retraining may include generating one or more data sets (e.g., via data set generator 172) utilizing historical data.

In some embodiments, the functions of client device 120, categorization server 112, server machine 170, and server machine 180 may be provided by a fewer number of machines. For example, in some embodiments server machines 170 and 180 may be integrated into a single machine, while in some other embodiments, server machine 170, server machine 180, and categorization server 112 may be integrated into a single machine. In some embodiments, client device 120 and categorization server 112 may be integrated into a single machine. In some embodiments, functions of client device 120, categorization server 112, server machine 170, server machine 180, and data store 140 may be performed by a cloud-based service.

In general, functions described in one embodiment as being performed by client device 120, categorization server 112, server machine 170, and server machine 180 can also be performed on categorization server 112 in other embodiments, if appropriate. In addition, the functionality attributed to a particular component can be performed by different or multiple components operating together. For example, in some embodiments, the categorization server 112 may determine the corrective action based on the categorization data 163. In another example, client device 120 may determine the categorization data 163 based on output from the trained machine learning model.

In addition, the functions of a particular component can be performed by different or multiple components operating together. One or more of the categorization server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 2 depicts a block diagram of example data set generator 272 (e.g., data set generator 172 of FIG. 1) to create data sets for training, testing, validating, calibrating, etc. a model (e.g., model 190 of FIG. 1), according to some embodiments. Each data set generator 272 may be part of server machine 170 of FIG. 1. In some embodiments, data set generator 272 may generate data sets to be utilized in generating, validating, etc., machine learning models in association with the manufacturing equipment. In some embodiments, several models associated with manufacturing equipment 124 may be trained, used, and maintained (e.g., within a manufacturing facility). One or more trained machine learning models may be generated and maintained in association with the manufacturing equipment. Each model may be associated with one data set generators 272, multiple models may share a data set generator 272, etc.

FIG. 2 depicts a system 200 including data set generator 272 for creating data sets for one or more supervised models (e.g., including data associated with input to a model and output from the model). Data set generator 272 may create data sets (e.g., data input 210, target output 220) using historical data, which may include manufacturing parameters, manufacturing components, categorizations, nicknames, or the like. In some embodiments, a data set generator similar to data set generator 272 may be utilized to train an unsupervised model, e.g., target output 220 may not be generated by data set generator 272.

Data set generator 272 may generate data sets to train, test, and validate a model, e.g., a machine learning model. In some embodiments, data set generator 272 may generate data sets for training, testing, and/or validating a model configured to predict categorization of parameters and/or components in a substrate processing system, such as generating data indicating a criticality of a parameter value, a subsystem associated with a component, or the like.

A model to be generated (e.g., trained, calibrated, or the like) may be provided with a set of component and/or parameter names 242-1 as data input 210. The set of component and/or parameter names 242-1 may include names for distinguishing various components and/or parameters (e.g., sensors and equipment constants) associated with a manufacturing system. The set of component and/or parameter names 242-1 may include parameters determining actions of manufacturing equipment, such as ramp times for valve actuation.

Data set generator 272 may be used to generate data sets for any type of model used in association with generating data associated with categorization or understanding of functions of manufacturing system components or parameters. For example, data set generator 272 may be used to generate data sets for models to predict criticality, predict subsystem, predict (and/or enact) data access parameters, generate nicknames, etc.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data set generator 272 may generate a first data input corresponding to a first set of manufacturing parameters 252-1 to train, validate, or test a first machine learning model. Data set generator 272 may generate a second data input corresponding to a second set of historical manufacturing parameter data (e.g., a set of historical metrology data 252-2, not shown) to train, validate, or test a second machine learning model. Further sets of historical data may further be utilized in generating further machine learning models. Any number of sets of historical data may be utilized in generating any number of machine learning models, up to a final set, set of component and/or parameter names 242-N (N representing any target quantity of data sets, models, etc.)

In some embodiments, data set generator 272 may generate a first data input corresponding to a first set of component and/or parameter names 242-1 to train, validate, or test a first machine learning model. Data set generator 272 may generate a second data input corresponding to a second set of component and/or parameter names 242-2 (not shown) to train, validate, or test a second machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. In some embodiments, data set generator 272 may generate data for training a model configured to output predicted categorizations of components and/or parameters, as output categorization data 268. Data inputs 210 may also be referred to as “features,” “attributes,” or “information.” In some embodiments, data set generator 272 may provide the data set to training engine 182, validating engine 184, or testing engine 186, where the data set is used to train, validate, or test the model (e.g., one of the machine learning models that are included in model 190, ensemble model 190, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., categorization data 163 of FIG. 1), according to some embodiments. In some embodiments, system 300 may be used in conjunction with a machine learning model configured to generate predictive categorizations of parameters and/or components of a manufacturing system. In some embodiments, system 300 may be used in conjunction with a machine learning model to determine a corrective action associated with manufacturing equipment. In some embodiments, system 300 may be used in conjunction with a machine learning model to determine a fault of manufacturing equipment.

At block 310, system 300 (e.g., components of categorization system 110 of FIG. 1) performs data partitioning (e.g., via data set generator 172 of server machine 170 of FIG. 1) of data to be used in training, validating, and/or testing a machine learning model. In some embodiments, training categorization data 364 includes historical data, such as historical parameter and/or component names, categorization data related to the parameters and components, further data of interest (e.g., nicknames) associated with the parameter and components, etc. Training categorization data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item to generate an output. The output may include, for example, a predicted categorization. The output may be compared to a label of the training data item (e.g., an assigned categorization provided by a subject matter expert).

Processing logic may then compare the generated output (e.g., predicted categorization) to the label (e.g., assigned categorization) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set and to generate a second trained model using the second set of features in the training set. In some embodiments, the first trained model and the second trained model may be combined to generate a third trained model (e.g., which may be a better predictor or synthetic data generator than the first or the second trained model on its own). In some embodiments, sets of features used in comparing models may overlap. In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set and the second trained model using the second set of features in the validation set. In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set, the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, output data 324. Current data 322 may be related to a process, operation, or action of interest. Current data 322 may be manufacturing parameters related to a process under development, redevelopment, investigation, etc. A corrective action associated with the manufacturing equipment 124 of FIG. 1 may be performed in view of output data 324. In some embodiments, current data 322 may correspond to the same types of features in the historical data used to train the machine learning model. In some embodiments, current data 322 corresponds to a subset of the types of features in historical data that are used to train selected model 308. In some embodiments, a corrective action may include updating one or more manufacturing parameters, e.g., based on reference values, criticality categorization, indications of malfunctioning or underperforming subsystems, subsystem assignment, or the like.

In some embodiments, the performance of a machine learning model trained, validated, and tested by system 300 may deteriorate. For example, a manufacturing system associated with the trained machine learning model may undergo a gradual change or a sudden change, naming conventions for parameters or components may change, or the like. In another example, a general purpose machine learning model (e.g., an LLM) may be used initially for performing categorization operations, and the machine learning may be updated, adjusted, or retrained to improve performance of the model (e.g., to increase accuracy of output data 324). A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training 312 for generation of one or more new machine learning models, updating, retraining, and/or refining of selected model 308, etc.

In some embodiments, retraining of the model may be performed by adjusting a subset of parameters of the model. For example, an LLM may be tuned for a particular purpose (e.g., categorization and related functions of manufacturing system components and parameters) by allowing a subset of the model parameters to be adjusted based on retraining data. This may enable accurate and efficient retraining of the model, while reducing the risk of overtraining (e.g., overfitting) of the model to the retraining data.

In some embodiments, retraining of the model may include parameter-efficient fine-tuning operations. Parameter-efficient fine-tuning techniques may be computational resource-efficient, e.g., compared to full retraining adjusting all parameters of a pre-trained model to a specific task. Parameter-efficient fine-tuning techniques may involve or be effective with fewer retraining data points than full retraining operations including every parameter of the model. Several types of parameter-efficient fine-tuning may be utilized.

Model retraining may include low-rank adaptation, a type of parameter-efficient fine-tuning. Low-rank adaptation includes adding low-rank matrices to weighting matrices of the machine learning model. During the retraining operations, only the low-rank matrices are updated. In low-rank adaptation, the changes included for retraining may occupy a lower-dimensional space, reducing parameters to be adjusted.

Model retraining may include parameter-efficient transfer learning. Parameter-efficient transfer learning may include a combination of frozen and adjustable parameters. Some layers of a model may be frozen, while others are tunable. In some embodiments, some parameters within a layer may be frozen while others are trainable.

Model retraining may include adapter layer techniques. Adapter layers may include introducing small layers between existing layers of the pre-trained model. During retraining, only the adapter layer are tuned. Model retraining may include bias tuning. In bias tuning, only bias models are fine-tuned, leaving the main weight matrices unchanged. In some embodiments, a combination of techniques may be utilized, e.g., by including adapter layers as well as allowing tuning of some parameters of the model, while freezing others.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., names of parameters of manufacturing equipment, names of sensors of manufacturing equipment, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-C are flow diagrams of methods 400A-C associated with training and utilizing machine learning models, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by categorization system 110. Method 400A may be performed, in part, by categorization system 110 (e.g., server machine 170 and data set generator 172 of FIG. 1, data set generator 272 of FIG. 2). Categorization system 110 may use method 400A to generate a data set to at least one of train, validate, or test a machine learning model, in accordance with embodiments of the disclosure. Methods 400B-C may be performed by categorization server 112 (e.g., categorization component 114) and/or server machine 180 (e.g., training, validating, and testing operations may be performed by server machine 180). In some embodiments, a non-transitory machine-readable storage medium stores instructions that when executed by a processing device (e.g., of categorization system 110, of server machine 180, of categorization server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of parameter data, component data, etc. In some embodiments, the first data input may include a first set of features for types of data and a second data input may include a second set of features for types of data (e.g., as described with respect to FIG. 3). Input data may include historical data.

In some embodiments, at block 403, processing logic optionally generates a first target output for one or more of the data inputs (e.g., first data input). In some embodiments, the input includes one or more categorizations related to the parameter or component inputs. In some embodiments, the input includes an abbreviated name or nickname for the parameter or component (e.g., to assist a user such as a technician in understanding at a glance the function of the parameter or component). In some embodiments, output may include a data access categorization.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by categorization component 114 (of categorization server 112) to generate categorization data 163 for classifying parameter or components, or for performing a corrective action associated with manufacturing equipment 124.

FIG. 4B is a flow diagram of a method 400B for utilizing an AI model via prompt engineering to perform classification of parameters or components of a manufacturing system, according to some embodiments. At block 410, process logic generates or receives an input for an AI model. The AI model may be a natural language processing model, an LLM, etc. The AI model may be a general purpose model. The AI model may be a model specifically trained (or retrained or adjusted) to perform operations related to categorization of manufacturing equipment.

In some embodiments, process logic may obtain a prompt (e.g., user generated prompt engineering) including one or more features for improving categorization operation of the model. In some embodiments, process logic may engineer a prompt. For example, process logic may be provided with a name of a target parameter or component of a manufacturing system, and generate a prompt based on the target parameter or component. The process logic may select from a list of available prompt engineering data a number of prompt components for including in a prompt. For example, the process logic may select based on metadata of the target parameter or component, similar to data tags of available prompt engineering data. The process logic may select prompt engineering data based on similarity of names, e.g., similar strings of characters including in names of target parameters and names of parameters stored as prompt engineering data.

A prompt for the AI model (either user-generated or process-logic generated, by selection of a number of sets of prompt engineering data from a list of prompt engineering data) may include a description of a set of categories to which a parameter or component of a manufacturing system may belong. The prompt may further include a plurality of examples, each including a parameter or component name (e.g., example input data) and an indication of which category the parameter or component belongs to (e.g., example output data). Example output data may further include other data of interest, e.g., abbreviated names or nicknames, data access permissions, or the like. The prompt further may include a name of a target parameter or component to be categorized according to the set of categories included in the prompt. Categorization may include degree of criticality, subsystem assignment, data access permissions, or the like.

Prompt engineering may include providing categorization schemes. For example, a description of a number of categories belonging to a first categorization may be included. To illustrate, a prompt may include a description of a criticality group 1, with no correlation to substrate performance, a criticality group 2, with some correlation to substrate performance, and a criticality group 3, with high correlation to substrate performance. Further portions of a prompt may provide instructions related to formatting output, e.g., instructions for the model to provide an output file, to provide only data classifications without additional commentary, or the like. A prompt may appear sharing one or more features with example engineered prompt, below, for providing output related to a transfer robot parameter:

Please categorize and group the following manufacturing parameter.

See below for possible categories:

### Category: 1

Description: no importance to output properties

### Category: 2

Description: low importance to output properties

### Category: 3

Description: important to output properties

### Category: 4

Description: critical to output properties

See below for possible groups:

### Group: 1

Description: related to handling and supplying of process gas

### Group: 2

Description: related to generating plasma

### Group: 3

Description: related to temperature control

### Group: 4

Description: related to transport of substrates

See below some examples of input and associated output:
Input: manifoldvalveactuationvalue
Category: 2
Group: 1
Input: Rfimpedancematch
Category: 4
Group: 2
Input: transferrobotmotorvalue

In some embodiments, several inputs for categorization may be provided with a single prompt. In some embodiments, e.g., in the case of process logic generating a prompt, a number of prompts may be generated (e.g., using different example input/output pairs), and either a most common output, average output, output with highest confidence, or the like may be utilized.

Upon receiving or generating such a prompt, as block 412, process logic may process the input using the AI model. Processing the input may include generating output comprising at least one category (e.g., category of criticality, category of data accessibility, category of subsystem, etc.). Processing the input may include generating an output including an abbreviated name or nickname. In some embodiments, prompt engineering may include instructions to determine some outputs based on other outputs. For example, the prompt may indicate that for inputs that are at least of a threshold criticality, to generate a nickname for use by technicians or other users.

At block 414, a corrective action is performed in view of the category data output by the model. The corrective action may include facilitating user access based on an output data access description, data access category, data access permission level, or the like. Facilitating user access may include updating data tags or metadata associated with sensor data, associated with the parameter or component, or the like. Performing the corrective action may include updating one or more parameters, e.g., equipment constants. Upon determining that an equipment constant or other parameter may be relevant to a manufacturing system, operations may be taken to adjust or improve a value of the parameter. Relevance may include criticality, subsystem assignment, a difference between a value of the parameter and one or more reference values, or the like. In some embodiments, a corrective action may not be performed based on the output data. In some embodiments, output data may be utilized to create or update further machine learning models, e.g., criticality predictions may be used as training data to train an additional machine learning model for further applications.

FIG. 4C is a flow diagram of a method 400C for training a machine learning or AI model to perform classification operations, according to some embodiments. At block 420, process logic obtains training data. The training data may include names of a plurality of parameters or components of one or more manufacturing systems. The parameters may include equipment constants. The components may include sensors. The training data may further include categorizations of each of the plurality of parameters or components. In some embodiments, additional data streams may be included or utilized. For example, training data my include alarms triggered during processing (e.g., along with target output indicative of whether the alarm is of high consequence to substrate outcomes). Training data may include events recorded by the process tool (e.g., with target output including criticality of the events).

There may be multiple types, sets, or groups of categorizations, e.g., a categorization of level of criticality, a categorization of subsystem, a categorization of one or more groups of users who are to have access to data associated with the parameter or component (e.g., access to parameter values, access to data generated by the sensor, or the like), etc. In some embodiments, the training data may further include abbreviated names or nicknames for at least a subset of the plurality of parameters or components (e.g., components of high criticality).

At block 422, process logic updates one or more parameters of a trained AI model to generate a retrained model, e.g., process logic retrains the AI model. The retrained model may be configured to perform classification of manufacturing system components and/or parameters. The model may be configured to receive as input a name of a target parameter or component and generate output indicating classification of the component into a category corresponding to the categorizations of each of the plurality of parameters or components. The model may be configured to obtain an engineered prompt, including descriptions of target output, example categorizations, descriptions of one or more categories of interest, etc., in addition to the input name of the target parameter or component for classification. The output may additionally include a nickname or abbreviated name for the target parameter or component. The retraining operations may include parameter-efficient fine-tuning, low-rank adaptation, etc.

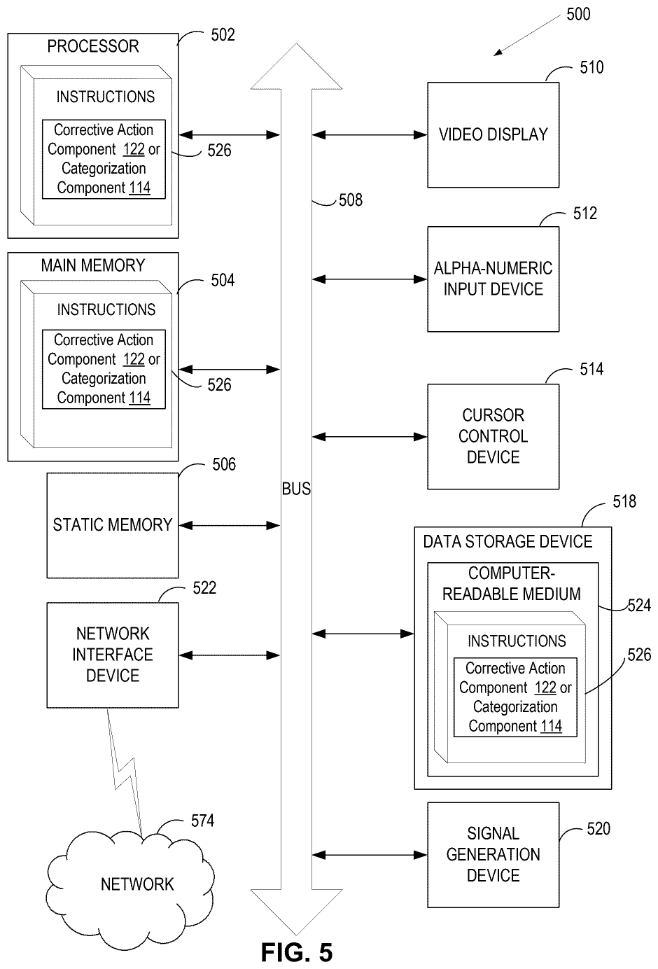

FIG. 5 is a block diagram illustrating a computer system 500, according to some embodiments. In some embodiments, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which may communicate with each other via a bus 508.

Processing device 502 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 500 may further include a network interface device 522 (e.g., coupled to network 574). Computer system 500 also may include a video display unit 510 (e.g., an LCD), an alphanumeric input device 512 (e.g., a keyboard), a cursor control device 514 (e.g., a mouse), and a signal generation device 520.

In some embodiments, data storage device 518 may include a non-transitory computer-readable storage medium 524 (e.g., non-transitory machine-readable medium, non-transitory machine-readable storage medium, or the like) on which may store instructions 526 encoding any one or more of the methods or functions described herein, including instructions encoding components of FIG. 1 (e.g., categorization component 114, corrective action component 122, model 190, etc.) and for implementing methods described herein.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method comprising:
generating or receiving an input for an artificial intelligence (AI) model, the input comprising:
a description of a set of categories to which a parameter or component of a manufacturing system may belong,
a plurality of examples each comprising a parameter or component name and an indication of which category of the set of categories the parameter or component belongs to, and
a name of a target parameter or component to be categorized according to the set of categories;
processing the input using the AI model to generate an output comprising a category associated with the target parameter or component; and
performing a corrective action in view of the category associated with the target parameter or component.

2. The method of claim 1, wherein the AI model comprises a large language model (LLM).

3. The method of claim 1, wherein the set of categories comprises a set of subsystems of the manufacturing system.

4. The method of claim 1, wherein the set of categories comprises a degree of criticality of the parameter, wherein criticality is determined by a strength of a relationship between values of the parameter and properties of a product processed by the manufacturing system.

5. The method of claim 1, wherein the target parameter or component comprises an equipment constant or a sensor of the manufacturing system.

6. The method of claim 1, wherein each of the plurality of examples further comprises an abbreviated parameter or component name, and wherein the output from the AI model further comprises a target abbreviated name in association with the target parameter or component.

7. The method of claim 1, wherein the set of categories comprises a data access classification, and wherein data associated with the target parameter or component is to be provided to a set of users based on the data access classification.

8. The method of claim 1, wherein the target parameter or component comprises an equipment constant, and wherein the method further comprises:
determining that a value of the equipment constant associated with the manufacturing system is different than a reference value, and wherein the corrective action comprises updating the equipment constant in further view of the reference value.

9. A method, comprising:
obtaining, by a processing device, a plurality of training data, the training data comprising:
names of a plurality of parameters or components of one or more manufacturing systems, and
categorizations of each of the plurality of parameters or components;
updating one or more parameters of a trained artificial intelligence (AI) model to generate a retrained AI model, wherein the retrained AI model is configured to receive as input a name of a target parameter or component, and generate output indicating classification of the component into a category corresponding to the categorizations of each of the plurality of parameters or components.

10. The method of claim 9, wherein updating one or more parameters of the trained AI model to generate the retrained AI model comprises performing parameter-efficient fine-tuning operations to update a subset of parameters of the AI model.

11. The method of claim 10, wherein the parameter-efficient fine-tuning comprises low-rank adaptation operations.

12. The method of claim 9, wherein categories of the categorization comprise one or more of:
level of criticality to properties of a manufactured product of the one or more manufacturing systems; or
subsystem of the one or more manufacturing systems.

13. The method of claim 9, wherein the plurality of components of the one or more manufacturing systems comprise one or more of:
equipment constants; or
sensors.

14. The method of claim 9, wherein the training data further comprises abbreviated names of the plurality of parameters or components, and wherein the retrained AI model is further configured to generate output predicting an abbreviated name of the target parameter or component indicative to a user of a function of the target parameter or component.

15. The method of claim 9, wherein the categorization comprises a data access classification, and wherein a set of users associated with a first category of the data access classification is to be granted access to data in association with the target parameter or component, while a second set of users associated with a second category of the data access classification is not to be granted access to data in association with the target parameter or component.

16. A non-transitory machine-readable storage medium storing instructions which, when executed, cause a processing device to perform operations comprising:
generating or receiving an input for an artificial intelligence (AI) model, the input comprising:
a description of a set of categories to which a parameter or component of a manufacturing system may belong,
a plurality of examples each comprising a parameter or component name and an indication of which category of the set of categories the parameter or component belongs to, and
a name of a target parameter or component to be categorized according to the set of categories;
processing the input using the AI model to generate an output comprising a category associated with the target parameter or component; and
performing a corrective action in view of the category associated with the target parameter or component.

17. The non-transitory machine-readable storage medium of claim 16, wherein the set of categories comprises a set of subsystems of the manufacturing system or a degree of criticality of the parameter, wherein criticality is determined by a strength of a relationship between values of the parameter and properties of a product processed by the manufacturing system.

18. The non-transitory machine-readable storage medium of claim 16, wherein the target parameter or component comprises and equipment constant or a sensor of the manufacturing system.

19. The non-transitory machine-readable storage medium of claim 16, wherein the set of categories comprises a data access classification, and wherein data associated with the target parameter or component is to be provided to a set of users based on the data access classification.

20. The non-transitory machine-readable storage medium of claim 16, wherein the target parameter or component comprises an equipment constant, and wherein the operations further comprise determining that a value of the equipment constant associated with the manufacturing system is different than a reference value, and wherein the corrective action comprises updating the equipment constant in further view of the reference value.
